(19) United States
(12) Patent Application Publication
(10) Pub. No.: US 2014/0091620 A1
(43) Pub. Date: Apr. 3, 2014

(54) ELECTRIC ENERGY CONVERTER

(71) Applicants: Philippe Aubin, Chanceaux Sur Choisille (FR); Martin Coyaud, Tours (FR)

(72) Inventors: Philippe Aubin, Chanceaux Sur Choisille (FR); Martin Coyaud, Tours (FR)

(21) Appl. No.: 14/114,334

(22) PCT Filed: Apr. 27, 2012
(86) PCT No.: PCT/FR12/50943

§ 371 Date: Dec. 5, 2013

(30) Foreign Application Priority Data
Apr. 28, 2011 (FR) 1153627

(51) Int. Cl. H02J 4/00

(52) U.S. Cl. CPC H02J 4/00
USPC 307/11

(57) ABSTRACT

An electric energy converter generates a first output signal (S1) and a second output signal (S2) and includes switching elements (10), the converter including at least two bridge arms (10a, 10b, 10c) adapted to generate the first output signal (S1), with a transformer generating the second output signal (S2) simultaneously with the first output signal. The bridge arms (10a, 10b, 10c) are controlled such as to generate the second output signal (S2), the second output signal (S2) being a function of a midpoint voltage equivalent to the sum of the output voltages (E₁, E₂, E₃) of the bridge arms (10a, 10b, 10c) in relation to a midpoint of the input voltage at the switching elements (10). The use thereof in a train is also described.

The present invention relates to an electric energy converter generating a first output signal and a second output signal.

Such a converter comprises switching means comprising at least two bridge arms adapted to generate the first output signal.

For example, the converter can generate a single-phase or a three-phase signal.

There are converters which generate moreover a continuous (DC) second output.

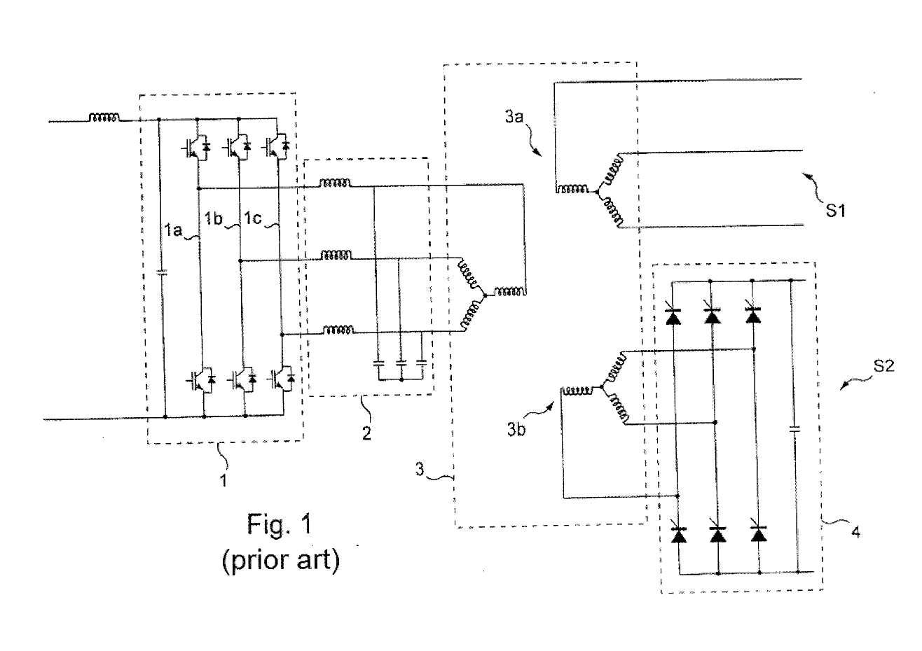

For example, FIG. 1 shows an electric energy converter capable of converting a continuous signal (DC signal) that it receives on input into a three-phase output signal S1, as well as into a continuous output signal S2.

The converter shown in FIG. 1 comprises switching means 1 comprising three bridge arms 1a, 1b, 1c, a sine filter 2 for eliminating the chopping frequency of the switching means 1, and an isolating transformer 3.

In this example, each bridge arm 1a, 1b, 1c of the switching means comprises two IGBT (Insulated Gate Bipolar Transistor) transistors which operate like switches.

The isolating transformer 3 comprises two secondaries 3a, 3b. A first secondary 3a is dedicated to the generation of the three-phase output signal S1 and a second secondary 3b is dedicated to the generation of the continuous output signal S2.

A thyristor bridge 4 is connected to the output of the second secondary 3b.

The purpose of the thyristor bridge 4 is to rectify the alternating voltage (AC voltage) for the purpose of charging a battery.

Such a system is not very suitable for low output voltage values, like that of a battery, because of the losses in the thyristors of the thyristor bridge 4.

Moreover, when the power of the battery charger (the part of the converter corresponding to the second secondary 3b and the thyristor bridge 4) is greater than 25% of the power of the converter, the three-phase output signal S1 is highly distorted.

Thus, the performance of a converter such as the one shown in FIG. 1 is limited.

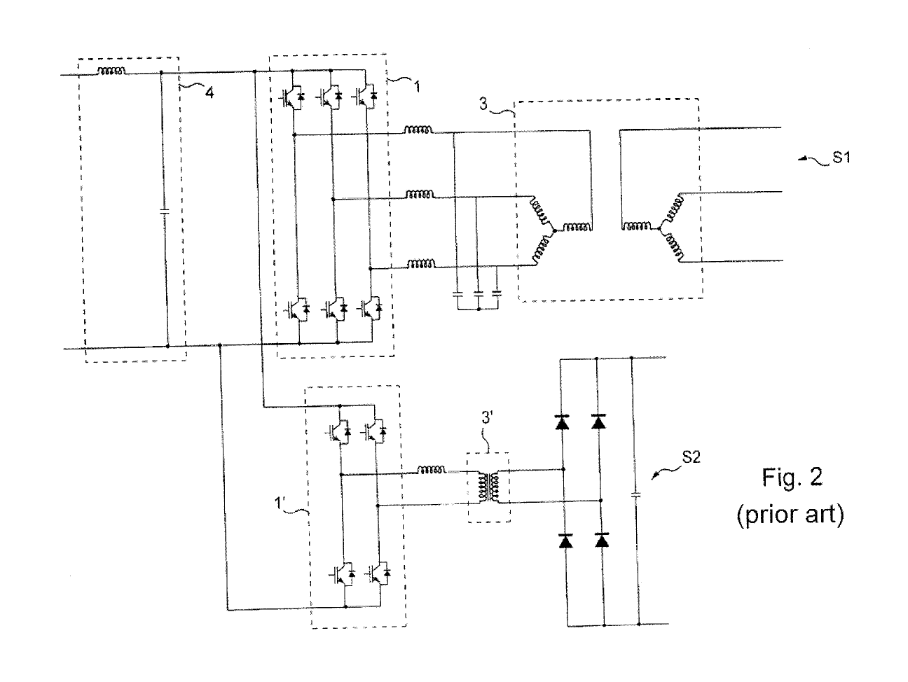

This problem is solved by a converter such as the one shown in FIG. 2. This converter comprises first switching means 1 and a first transformer 3 which generate a three-phase output signal S1. It also comprises second switching means 1′, a second transformer 3′, a rectifier bridge and a filtering capacitor which generate a continuous or DC output signal S2.

However, such a converter is not optimum in terms of size and cost since all of the components of the converter are duplicated, except for the input filter 4.

The purpose of the present invention is to propose an electric energy converter generating a first output signal and a second output signal, having reduced size and cost without however exhibiting degraded performance.

For this purpose, the present invention proposes an electric energy converter generating a first output signal and a second output signal, and comprising switching means comprising at least two bridge arms and being adapted to generate said first output signal.

According to the invention, the electric energy converter comprises a transformer generating the second output signal, the bridge arms being controlled in order to generate the second output signal simultaneously with the first output signal, said second output signal being a function of a midpoint voltage equivalent to the sum of the output voltages of the bridge arms with respect to the midpoint of the input voltage of said switching means.

Thus, the first output signal and the second output signal are generated from the same switching means. As a result, the converter having single switching means has reduced size as well as reduced cost.

Using this topology, two separate output signals can be obtained simultaneously.

According to a feature, the electric energy converter comprises filtering means adapted to eliminate the chopping frequency of the switching means.

Thus, the second output signal is a function of the voltage equivalent to the sum of the output voltages of the bridge arms, once the chopping frequency has been eliminated or filtered.

According to a feature, the filtering means comprise capacitors respectively connected to each bridge arm by a first terminal, said capacitors being connected to each other by a second terminal, the second terminals being connected to a reference potential.

For example, the electric energy converter comprises a capacitor disposed between the second terminal of the capacitors of the filtering means and the reference potential.

In practice, each bridge arm of the switching means comprises at least two switches, the two switches of each bridge arm being controlled substantially in opposition by two control signals respectively, the control signals being generated from a first command signal and a second command signal, the first command signal and the second command signal being applied to each bridge arm, the first command signal being applied with a phase shift such that the voltage of the midpoint is substantially zero.

Thus, the first command signal makes it possible to regulate the level of the first output signal and the second command signal makes it possible to regulate the level of the second output signal.

As a result, the levels of the first and second output signals are regulated independently of each other.

In practice, the phase shift has a value of 180° when the switching means comprise two bridge arms and a value of 120° when the switching means comprise three bridge arms.

For example, the frequency of the second command signal is higher than the frequency of the first command signal.

This makes it possible to further reduce the size of the converter.

For example, the frequency of the second command signal is three times higher than the frequency of the first command signal, when the switching means comprise three bridge arms.

According to a feature, the control signals are generated by a pulse width modulation (PWM) regulator controlled by a command signal the level of which is substantially equal to the sum of the first and second command signals.

For example, the transformer comprises a primary and at least one secondary, the second output signal being taken at the secondary, the first output being connected to a first point situated downstream of the switching means.

The second output signal is therefore generated electrically.

As a variant, the transformer is formed by windings that are respectively connected to each bridge arm, the first windings forming a primary of the transformer, and at least one second winding forming a secondary of the transformer, the second output signal being taken at the secondary.

Thus, the second output signal is generated magnetically.

In practice, the first windings are inductances of the filtering means.

For example, the converter comprises a second transformer connected to the bridge arms of the switching means, the first output signal being taken at the secondary of the second transformer, and the first point being the neutral of the primary of the second transformer.

Thus, the second transformer generates the first output signal and the first point is situated in the transformer.

In practice, the neutral of the primary of the second transformer is connected to the midpoint of the input voltage of the switching means.

For example, the primary of the second transformer comprises three windings, one terminal of each winding being connected to the reference potential through capacitors.

As a variant, a motor is connected to the bridge arms of the switching means, the first point being the neutral point of the motor.

Thus, the first output signal is used for powering the motor and the first point is situated in the motor.

According to a feature, the primary of the transformer is connected to the midpoint of the input voltage of the switching means. According to another variant, a capacitor is connected to each bridge arm by a first terminal and the capacitors are connected to each other by a second terminal, the first point being formed by the second terminals of the capacitors.

For example, the primary of the transformer is connected to the capacitors and to the reference potential.

For example, the first output signal can be a three-phase or single-phase alternating signal and the second output signal can be a single-phase alternating signal. These output signals can be rectified and filtered in order to generate continuous or DC output signals.

Other features and advantages of the invention will furthermore become apparent in the following description.

In the attached drawings, given as non-limitative examples:

FIG. 1 shows an example of an electric energy converter of the prior art;

FIG. 2 shows a second example of an electric energy converter of the prior art;

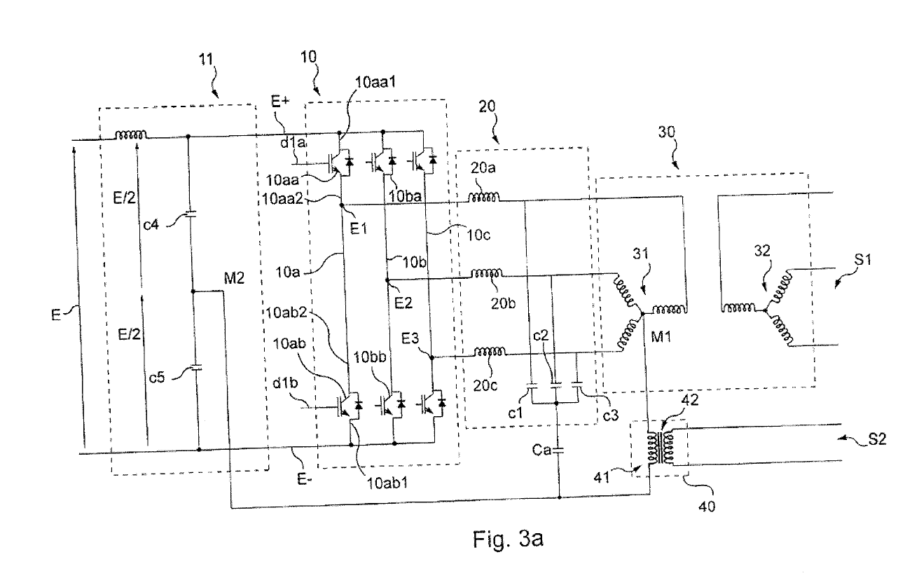

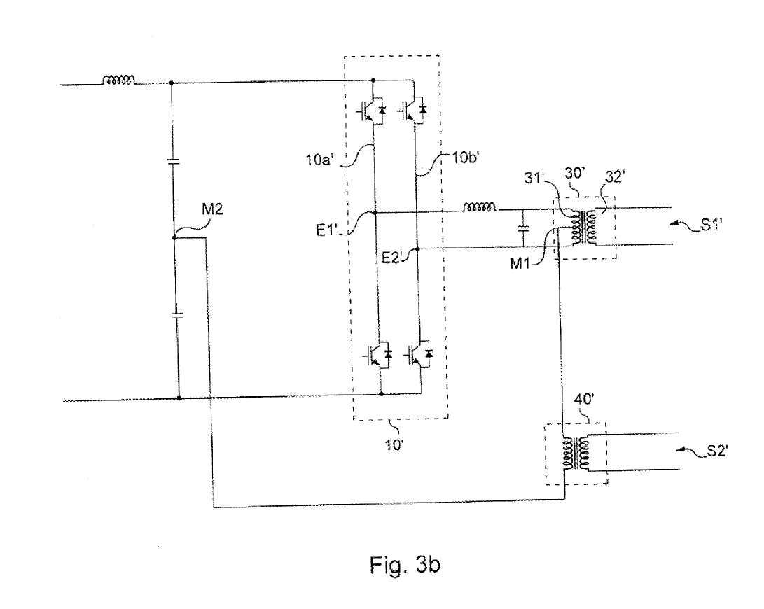

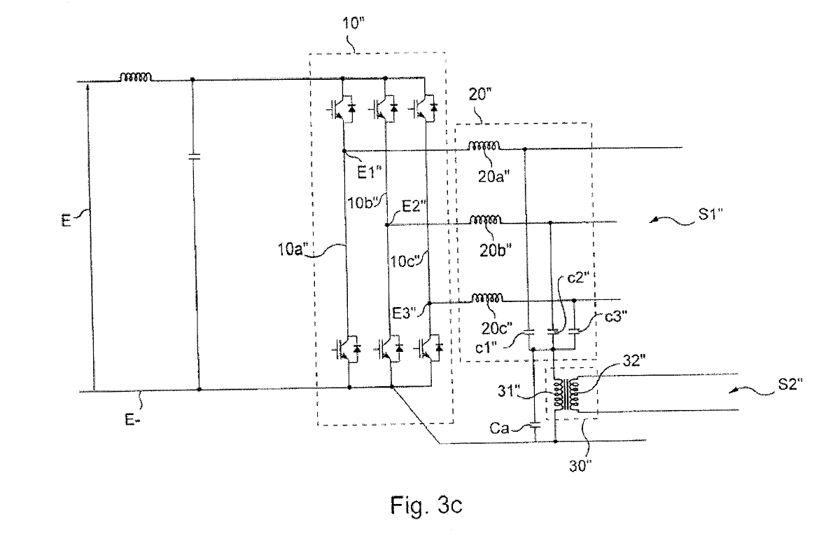

FIGS. 3a to 3c show variants of a first embodiment of an electric energy converter according to the invention;

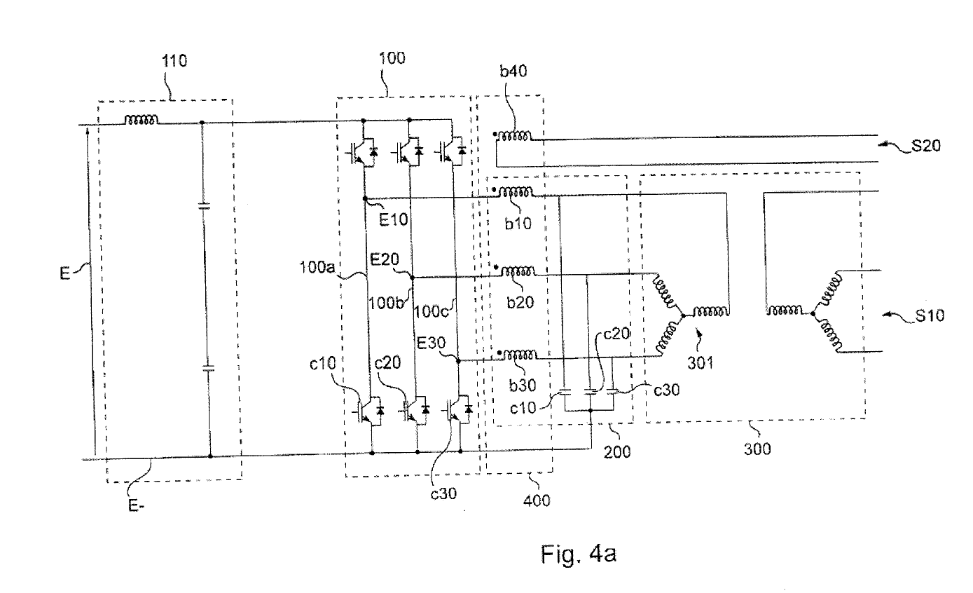

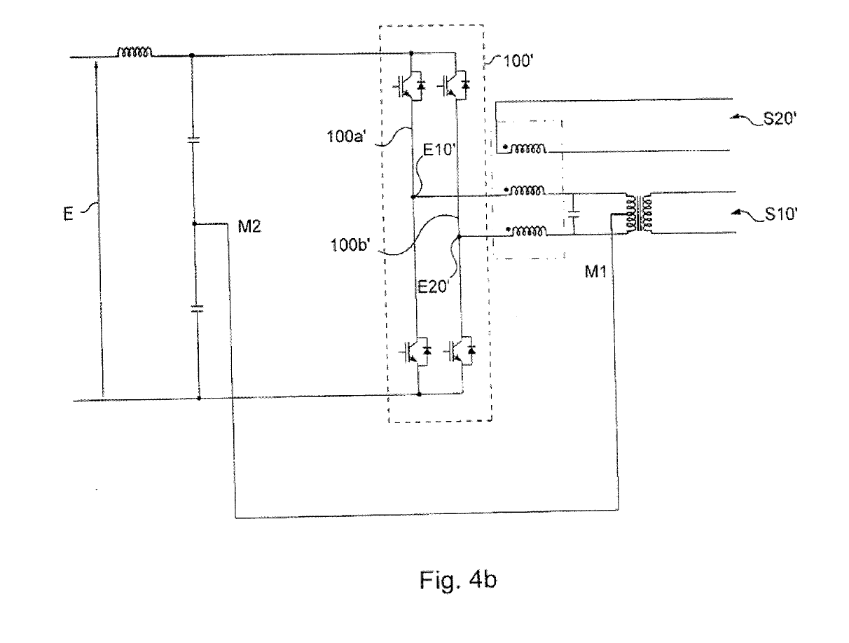

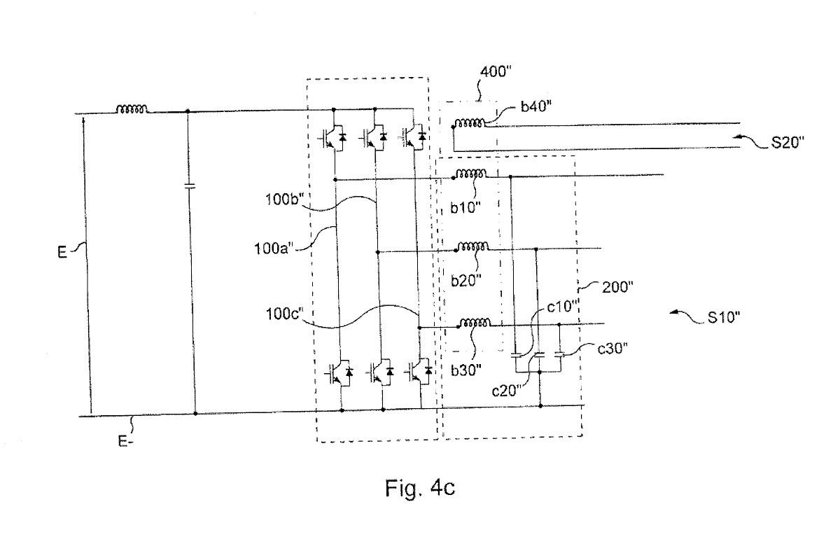

FIGS. 4a, 4b and 4c show variants of a second embodiment of an electric energy converter according to the invention;

FIG. 5a shows variant embodiments of a third embodiment of an electric energy converter according to the invention;

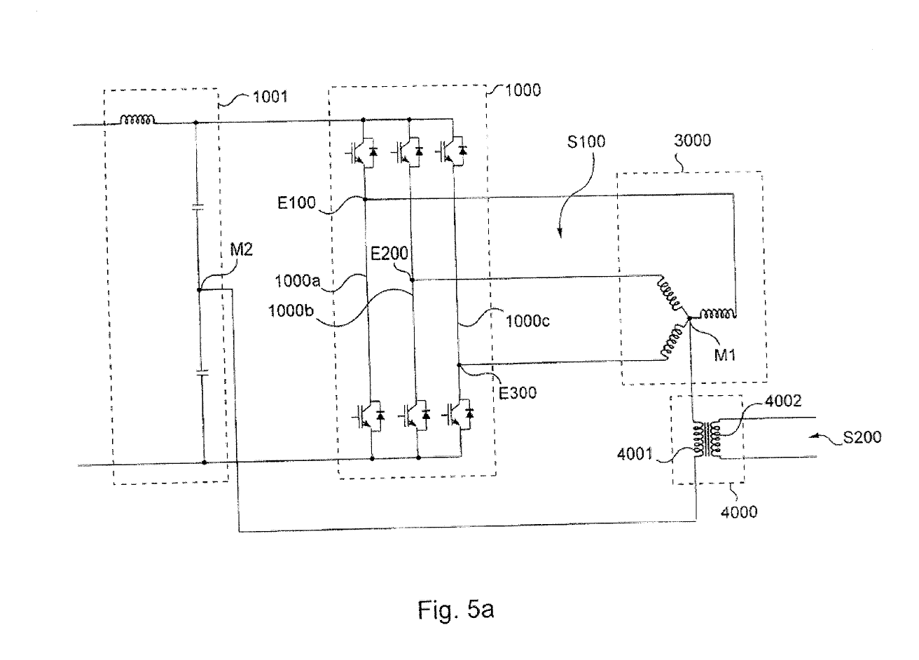

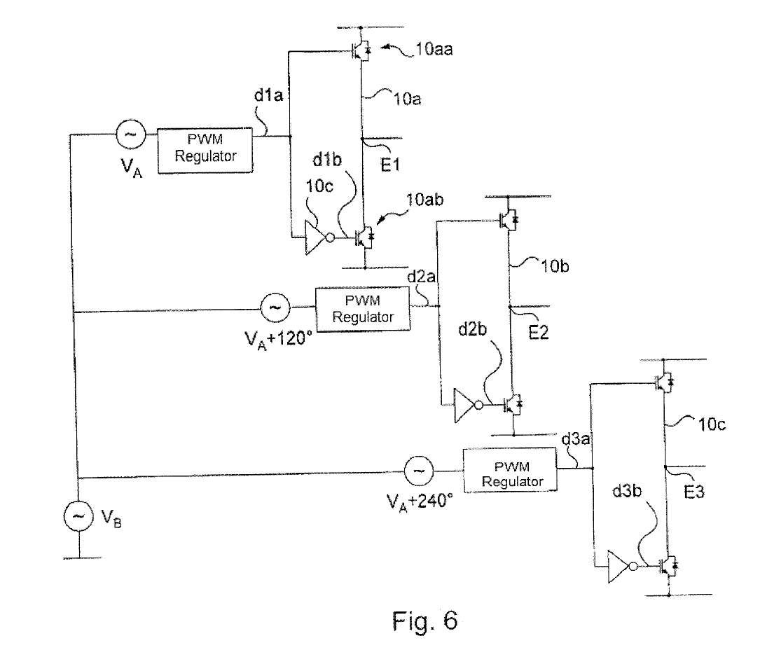

FIG. 6 shows an example of a control circuit of a switching circuit in an electric energy converter according to the invention; and

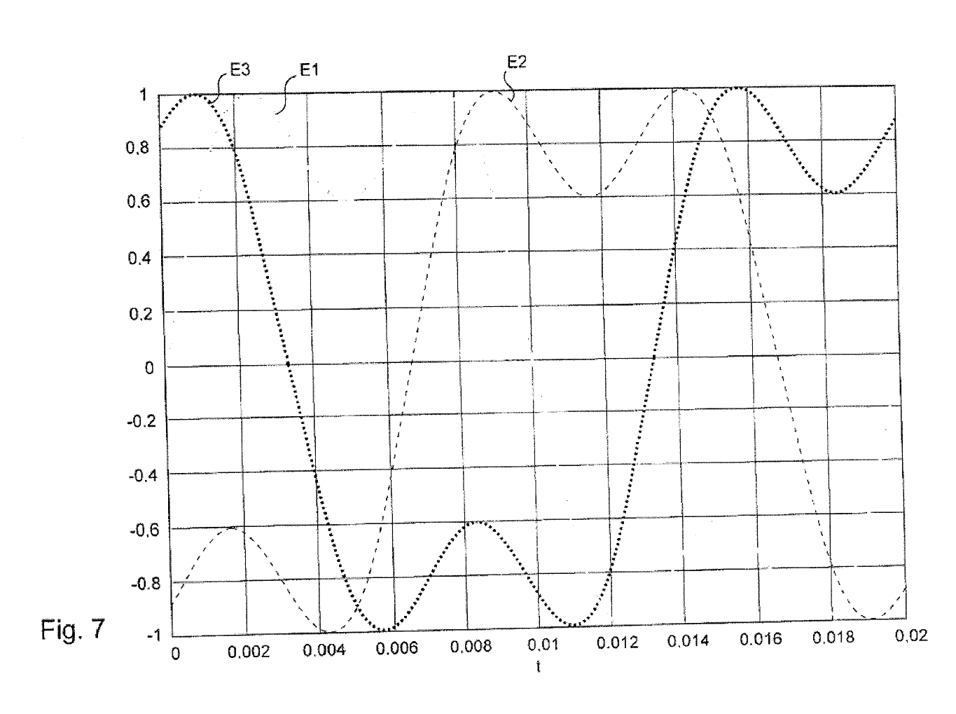

FIG. 7 shows output curves of a switching circuit in an electric energy converter according to the invention.

A first embodiment of an electric energy converter according to the invention will firstly be described with reference to FIG. 3a.

In this embodiment, a first output signal S1 and a second output signal S2 are generated from an input signal E of the converter.

In this embodiment, the input signal E, the first output signal S1, and the second output signal S2 are voltages.

In this example, the first output signal S1 is a three-phase voltage and the second output signal S2 is a single-phase voltage.

As an example that is in no way limitative, the input voltage E is a continuous or DC voltage having a value of 750 V, the three-phase output voltage has a value of 400 V and of 50 Hz, and the single-phase output voltage has a value of 24V and of 150 Hz.

For example, the first output signal S1 is used for supplying the three-phase network on board a train and the second signal, once rectified and filtered, is used for supplying the low voltage continuous or DC network and for charging the batteries of the train.

By way of example that is in no way limitative, the electrical power supply comes from a catenary or from a third rail intended to supply a train with electricity.

The input voltage E is applied to switching means or a switching circuit 10 after filtering by means of a filter 11.

In this example, the switching circuit 10 comprises three bridge arms 10a, 10b, 10c.

Each bridge arm comprises two IGBT (Insulated Gate Bipolar Transistor) transistors 10aa, 10ab, 10bb, 10ba which carry out the function of two switches.

In other embodiments, each bridge arm 10a, 10b could comprise more than two IGBT transistors, these IGBT transistors being able to be connected to one or more input voltages.

Moreover, other types of components having a switch function can be used.

Thus, a first bridge arm 10a comprises a first transistor 10aa connected by a first terminal 10aa1 to the positive pole of the input voltage E+ and a second transistor 10ab connected through a first terminal 10ab1 to the negative pole of the input voltage E−.

The first and second transistors 10aa, 10ab are connected to each other respectively by a second terminal 10aa2, 10ab2.

Thus, the first and second transistors 10aa, 10ab form the first bridge arm 10a.

The first transistor 10aa is controlled by a first control signal d1a.

The second transistor 10ab is controlled by a second control signal d1b.

The second 10b and third 10c bridge arms are similar to the first bridge arm and will not be described here.

The output voltages of the bridge arms E1, E2, E3 are taken at each bridge arm 10a, 10b, 10c respectively at the level of the branch which connects the two IGBT transistors 10aa, 10ab.

These three output voltages of the bridge arms E1, E2, E3 are filtered by means of a sine filter 20.

In this embodiment, the sine filter 20 is composed of three inductances 20a, 20b, 20c, each winding being connected by a first terminal to the midpoint or neutral point of a bridge arm 10a, 10b, 10c, i.e. at the level of the branch connecting the two IGBT transistors 10aa, 10ab.

Here, three capacitors c1, c2, c3 are connected to each other by a first terminal, and to each winding 20a, 20b, 20c respectively by a second terminal.

The function of this sine filter 20 is to eliminate the chopping frequency produced by the switching circuit 10.

The inductances 20a, 20b, 20c of the sine filter 20 are connected by a second terminal to the primary 31 of a transformer 30.

The first output signal S1 is taken at the secondary of the transformer 30 and the second output signal S2 is generated by a second transformer 40.

In this embodiment, the second output signal S2 is generated from the difference between a voltage taken at a first point M1 situated downstream of the switching circuit 10 and a second voltage taken at a second point M2 situated upstream of the switching circuit 10.

Here, the first point M1 is situated in the primary 31 of the transformer 30, in particular at the neutral point of the primary 31 of the transformer 30.

The second point M2 is situated at the level of the input filter 11 situated at the input of the switching circuit 10.

In particular, the first point M2 is situated between two capacitors c4, c5 of the input filter 11.

This second point M2 constitutes a midpoint of the input voltage E.

Thus, the potential difference between the negative pole E− of the input voltage E and the second point M2 has a value equivalent to half of the input voltage E, i.e. a value of E/2.

The same applies to the potential difference between the positive pole E+ of the input voltage E and the second point M2.

Thus, this midpoint of the input voltage corresponds to a point at which the voltage level is half of the maximum level of the input voltage, i.e. E/2.

This input filter is well known to a person skilled in the art and will not be described here.

In this example, the voltage taken at the first point M1 and the voltage taken at the second point M2 is applied to the primary 41 of a second transformer 40.

This voltage difference applied to the primary 41 of the second transformer 40 is a function of a midpoint voltage equivalent to the sum of the output voltages E1, E2, E3 of the bridge arms 10a, 10b, 10c with respect to the midpoint of the input voltage E of the switching circuit 10, i.e. with respect to the second point M2, or also with respect to a point corresponding to half of the input voltage E.

The second output signal S2 is taken at the secondary 42 of the second transformer 40.

Thus, the first output signal S1 and the second output signal S2 are generated from the same switching circuit 10.

Optionally, a capacitor Ca is connected by a first terminal to the first terminals of the three capacitors c1, c2, c3, and by a second terminal to the connexion at the point M2.

This configuration of four capacitors c1, c2, c3 and Ca prevents the chopping frequency of the switching circuit 10 from reaching the transformers 30, 40.

Thus, it is possible to reduce the voltage of the two output signals S1, S2 to zero, independently of each other.

Thus, for example, if it is desired to use only the first output signal S1, the voltage of the second output signal S2 can taken to zero.

The operation of the electric energy converter shown in FIG. 3a, as well as the control of the switching circuit 10 will be described below with reference to FIGS. 6 and 7.

FIG. 3b shows a variant of the first embodiment described above.

In this variant, the switching circuit 10′ comprises two bridge arms 10a′, 10b′.

The output voltage of the bridge arms E1′, E2′ is taken at each bridge arm 10a′, 10b′ of the switching circuit 10′ and applied to the primary 31′ of a first transformer 30′.

Thus, the first output signal S1′ is a single-phase signal, which is taken at the secondary 32′ of the first transformer 30′.

Apart from the above differences, the structure of the converter of this variant is equivalent to that of the converter shown in FIG. 3a and will not be described here.

In this example, as in the example of FIG. 3a, the second output signal S2′ is a single-phase signal which is taken at the output of a second transformer 40′.

It will be noted that the output signals S1, S1′, S2, S2′ can be rectified by means of a rectifier, such as for example a diode bridge or Graetz bridge.

Thus, in a variant embodiment, the converter comprises a rectifier connected to the output of the first 30 and/or second 40 transformer.

According to another variant, the rectifier can be connected to the output of the converter.

Thus, the output signals of the converter, once filtered by capacitors, can be DC signals.

Of course, other rectifier configurations can be used in order to obtain a DC output voltage.

Thus, it is possible to obtain a continuous or DC converter with galvanic isolation.

Another variant of the first embodiment of an electric energy converter according to the invention will now be described with reference to FIG. 3c.

In this embodiment, the switching circuit 10″ comprises three bridge arms 10a″, 10b″, 10c″.

The output signals of the bridge arms E1″, E2″, E3″ are connected to a sine filter 20″.

As in the preceding embodiments, the sine filter 20″ comprises three capacitors c1″, c2″, c3″. The capacitors c1″, c2″, c3″ are respectively connected by a first terminal to a coil 20a″, 20b″, 20c″ of the sine filter 20″, and to each other by a second terminal.

In this embodiment, the converter comprises a transformer 30″.

The second output signal S2″ is taken at the secondary 32″ of the transformer 30″.

The voltage of the midpoint equivalent to the sum of the output voltages E1″, E2″, E3″ of the bridge arms 10a″, 10b″, 10c″ with respect to the midpoint of the input voltage E is obtained by taking the potential difference between the second terminal of the capacitors c1″, c2″, c3″ of the sine filter 20″ and the negative terminal E− of the input voltage E of the converter.

This potential difference is applied to the primary 31″ of the transformer 30″. The fact of using capacitive coupling makes it possible not to be obliged to connect the second terminal of the transformer 30 to the midpoint of the input voltage E.

Here, the second output signal S2″ is a single-phase alternating signal.

The chopping frequency of the switching circuit 10″ is eliminated or filtered by placing a capacitor Ca in parallel with the primary 31″ of the transformer 30″.

The embodiment shown in FIG. 3c does not necessitate connection to the first and second points M1, M2, which is an advantage with respect to the other embodiments described. Its field of use is consequently more general and the converter is therefore all the more optimised.

A second embodiment of an electric energy converter according to the invention will now be described with reference to FIG. 4a.

In this embodiment, the switching circuit 100 comprises three bridge arms 100a, 100b, 100c.

The output voltage of the bridge arms E10, E20, E30 is taken at each bridge arm 100a, 100b, 100c and is applied to a sine filter 200 and then to a first transformer 300.

The first output signal S10 is a three-phase alternating signal which is taken at the output of the first transformer 300.

In this embodiment, the sine filter 200 uses the three windings b10, b20, b30. These three windings b10, b20, b30 form the primary of a second transformer 400.

As for the first embodiment, the sine filter 200 comprises three capacitors c10, c20, c30 connected to each other by a first terminal and respectively to each winding b10, b20, b30 by a second terminal.

In this embodiment, a fourth winding b40 is added, carrying out the function of a secondary of the second transformer 400.

The second output signal S20 is taken at the secondary of this second transformer 400, i.e. at the terminals of the fourth winding b40.

In this embodiment, the second output signal S20 is created due to the magnetic flux in the fourth winding b40. The voltage of the second output signal S20 is therefore directly dependant on the sum of the output voltages E10, E20, E30 of the bridge arms 10a, 10b, 10c with respect to the midpoint of the input voltage of the switching means 10.

Here, the second output signal S20 is a single-phase alternating signal.

In order to filter the chopping frequency of the switching circuit 100 on the second output signal S20 and to allow the generation of a magnetic flux in the fourth winding b40, the three capacitors c10, c20, c30 of the sine filter 200 are connected by their common terminal to the reference terminal E− of the input voltage E of the converter.

FIG. 4b shows a variant of the second embodiment of an electric energy converter according to the invention.

The diagram shown in FIG. 4b is equivalent to the one shown in FIG. 4a, and will not be described in detail here.

In this embodiment, the switching circuit 100′ comprises two bridge arms 100a′, 100b′, and the first output signal S10′ is a single-phase alternating signal.

The potential difference equivalent to the sum of the output voltages E10′, E20′ of the bridge arms of the switching circuit 100′ with respect to the midpoint of the input voltage E is retrieved magnetically (as described for FIG. 4a) in order to obtain the second output signal S20′, this second output signal S20′ being a single-phase alternating signal.

FIG. 4c shows another variant of the second embodiment of the electric energy converter according to the invention. In this variant, the first output signal S10″ is obtained at the output of the sine filter 200″.

The diagram shown in FIG. 4c is equivalent to the one shown in FIGS. 4a and 4b and will not be described in detail here.

In this variant, the switching circuit 100″ comprises three bridge arms 100a″, 100b″, 100c″, and the transformer 400″ is constituted by the windings b10″, b20″, b30″ of the sine filter 200″ and by a fourth winding b40″, as for the diagram shown in FIG. 4a.

Here, the common terminal of the three capacitors c10″, c20″, c30″ of the sine filter 200″ is connected to the reference terminal E− of the input voltage E of the converter.

The first output signal S10″ is taken directly at the output of the sine filter 200″.

A third embodiment of an electric energy converter according to the invention will now be described with reference to the FIG. 5a.

In this embodiment, the switching circuit 1000 comprises three bridge arms 1000a, 1000b, 1000c.

The output voltage of the bridge arms E100, E200, E300 is taken respectively at each bridge arm 1000a, 1000b, 1000c and applied to an inductive load 3000, here a three-phase motor.

Thus, the first output signal S100 is used for supplying electricity to this motor 3000.

The voltage difference between a first point M1 and a second point M2 is applied to the primary 4001 of a first transformer 4000.

The first point M1 is taken at the midpoint of the three-phase motor 3000.

The second point M2 is situated at the level of the filter 1001 situated at the input of the switching circuit 1000, as for FIGS. 3a, 3b and 4b.

The second output signal S200 is taken at the secondary 4002 of the first transformer 4000.

Here, the second output signal S200 is a single-phase alternating signal.

An example of control of a switching circuit used in an electric energy converter according to the invention will now be described with reference to FIG. 6.

In this example, three bridge arms of a switching circuit such as that used in the diagram shown in FIGS. 3a, 3c, 4a, 4c and 5a have been shown.

The first bridge arm 10a comprises two IGBT transistors 10aa, 10ab operating as switches.

These two IGBT transistors 10aa, 10ab are controlled by a first control signal d1a.

An inverter 10c is connected to the input of the second IGBT transistor 10ab so that the first 10aa and the second 10ab IGBT transistors may be controlled in opposition.

Thus, when the first IGBT transistor 10aa is controlled or commanded to open by the first control signal d1a, the second IGBT transistor 10ab is controlled or commanded to close by the first control signal d1a, i.e. by a signal d1b corresponding to the inverse of the first control signal d1a.

On the contrary, when the first IGBT transistor 10aa is controlled or commanded to close, the second IGBT transistor 10ab is controlled or commanded to open. However, in an improved embodiment, the two IGBT transistors 10aa, 10ab of a same bridge arm 10a, 10b, 10c are simultaneously controlled or commanded to open for a short period of time in order to prevent simultaneous switching of the transistors.

The first control signal d1a is generated by a first command signal V_{A} which is applied to a first PWM (Pulse Width Modulation) regulator.

The operation of such a regulator is known to a person skilled in the art and will not be described here.

Here, the first command signal V_{A} is generated by a sinusoidal voltage source.

The controls of the second 10b and third 10c bridge arms are similar to those of the first bridge arm and will not be described here.

In the case of the second bridge arm 10b, the first command signal V_{A} is applied to a second PWM regulator with a phase shift of 120° with respect to the first bridge arm 10a.

In the same way, for the third bridge arm 10c, the first command signal V_{A} is applied to a third PWM regulator with a phase shift of 120° with respect to the second bridge arm 10b, and as a result with a phase shift of 240° with respect to the first bridge arm 10a.

At the same time, a second command signal V_{B} is applied respectively to each PWM regulator corresponding to each bridge arm 10a, 10b, 10c.

Here, this second command signal V_{B} is generated by a second sinusoidal voltage source.

This second command signal V_{B} is applied identically (same voltage level and same phase shift) to the three bridge arms 10a, 10b, 10c.

FIG. 7 shows an example that is in no way limitative of the output signals E1, E2, E3 of the bridge arms 10a, 10b, 10c. For the purpose of better reading of the output signals E1, E2 and E3 of the bridge arms 10a, 10b, 10c, the chopping frequency of the switching means 10 has been removed from these signals in FIG. 7.

In this example, the first command signal V_{A} has a frequency of 50 Hz and the second command signal V_{B} has a frequency of 150 Hz and an amplitude variable between 0% and 40% of that of V_{A}.

The curve in continuous line represents the output signal E1 of the first bridge arm 10a, which corresponds to the superimposition of the first and second command signals V_{A}, V_{B}.

The curve shown in a dashed line represents the output signal E2 of the second bridge arm 10b, which corresponds to the superimposition of the first and second command signals V_{A}, V_{B}, the first command signal V_{A} having a phase shift of 120° with respect to the first command signal V_{A} applied to the first bridge arm 10a.

The curve shown in a dotted line represents the output signal E3 of the third bridge arm 10c, corresponding to the superimposition of the first and second command signals V_{A}, V_{B}, the first command signal V_{A} having a phase shift of 120° with respect to the first command signal V_{A} applied to the second bridge arm 10b.

When the second command signal V_{B} is zero and the first command signal V_{A} is applied to the bridge arms 10a, 10b, 10c with a phase shift such as described above, the midpoint voltage equivalent to the sum of the output voltages E1, E2, E3 of the bridge arms 10a, 10b, 10c of the switching circuit 10 is substantially zero. The first output signal S1 has a level, for example a voltage level, which is a function of the first command signal V_{A}.

On the contrary, when the first command signal V_{A} is zero and the second command signal V_{B} is applied to the three bridge arms 10a, 10b, 10c, the voltage differences between the output signals E1, E2, E3 of the bridge arms 10a, 10b, 10c taken two by two are substantially zero and the midpoint or neutral point voltage is a function of the second command signal V_{B}.

With the converter operating according to this configuration, it is possible to adjust the level, for example of voltage, of the second output signal S2 independently of the level, for example of voltage, of the first output signal S1. The level of the first output signal S1 is regulated by the level of the first command signal V_{A} and that of the second output signal S2 by that of the second command signal V_{B}.

The superimposition of the second command signal V_{B} on the first command signal V_{A} does not affect the maximum output voltage that can be achieved by the first output signal. It will be noted that the peak-to-peak amplitude of the output signals E1, E2 and E3 would be the same in the absence of the second command signal V_{B} as shown in FIG. 7.

When the switching circuit 10 comprises two bridge arms, i.e. the first signal is a single-phase alternating signal, the first command signal V_{A} is applied to each bridge arm 10a, 10b, 10c with a phase shift of 180°.

In an improved embodiment, the frequencies of the command signals V_{A} and V_{B} have different frequency values.

By way of example that is in no way limitative, the first command signal V_{A} has a frequency of 50 Hz and the second command signal V_{B} has a frequency of 150 Hz.

In the case of a switching circuit 10 comprising three bridge arms, when the frequency of the second command signal V_{B} is triple that of the first command signal V_{A}, the range of levels of the first output signal S1 is not affected by the presence of the second output signal S2. This implies an optimisation of the sizing of the converter making it possible to obtain a reduction of its cost.

The use of a higher frequency for the second command signal V_{B} allows the use of a smaller transformer for generating the second output signal.

Thus, the levels of the first and second command signals V_{A}, V_{B} respectively regulate the levels of the first and second output signals S1, S2. Thus, by means of the invention, an electric energy converter generating two output signals from the same switching means is obtained.

As a result, the size and the cost of such a converter are reduced with respect to converters of the prior art.

The two output signals correspond to a first output signal and to a second output signal which can be alternating. These output signals can be rectified and filtered in order to generate a continuous or DC output.

1. Electric energy converter generating a first output signal (51) and a second output signal (S2; S20; S200), and comprising switching means (10; 100; 1000) comprising at least two bridge arms (10a, 10b, 10c; 100a, 100b, 100c; 1000a, 1000b, 1000c) and being adapted to generate said first output signal (S1; S10; S100), the converter being characterized in that it comprises a transformer (40; 400; 4000) generating said second output signal (S2; S20; S200), said bridge arms (10a, 10b, 10c; 100a, 100b, 100c; 1000a, 1000b, 1000c) being controlled in order to generate said second output signal (S2; S20; S200) simultaneously with said first output signal (S1; S10; S100), said second output signal (S2; S20; S200) being a function of a midpoint voltage equivalent to the sum of the output voltages (E₁, E₂, E₃) of the bridge arms (10a, 10b, 10c; 100; 1000; 1000a, 1000b, 1000c) with respect to a midpoint of the input voltage of said switching means (10; 100; 1000).

2. Electric energy converter according to claim 1, characterized in that it comprises filtering means (20; 200) adapted to eliminate the chopping frequency of the switching means (10; 100; 1000).

3. Electric energy converter according to claim 2, characterized in that the filtering means (20; 200) comprise capacitors (c1, c2, c3; c10, c20, c30) respectively connected to each bridge arm (10a, 10b, 10c; 100; 1000) by a first terminal, said capacitors (c1, c2, c3; c10, c20, c30) being connected to each other by a second terminal, the second terminals being connected to a reference potential.

4. Electric energy converter according to claim 3, characterized in that it comprises a capacitor (Ca) disposed between the second terminal of the capacitors (c1, c2, c3) of the filtering means (20) and the reference potential.

5. Electric energy converter according to claim 1, characterized in that each bridge arm (10a, 10b, 10c; 100a, 100b, 100c; 1000a, 1000b, 1000c) of the switching means (10; 100; 1000) comprises at least two switches, said at least two switches of each bridge arm being controlled substantially in opposition by two control signals (d1a, d1b, d2a, d2b, d3a, d3b) respectively, the control signals (d1a, d1b, d2a, d2b, d3a, d3b) being generated from a first and a second command signal (V_{A}, V_{B}), the first command signal (V_{A}) and the second command signal (V_{B}) being applied to each bridge arm (10a, 10b, 10c; 100a, 100b, 100c; 1000a, 1000b, 1000c), the first command signal (V_{A}) being applied with a phase shift such that the voltage of the midpoint is substantially zero.

6. Electric energy converter according to claim 5, characterized in that said phase shift has a value of 180° when the switching means (10) comprise two bridge arms (10a, 10b) and a value of 120° when the switching means (10) comprise three bridge arms (10a, 10b, 10c).

7. Electric energy converter according to claim 5, characterized in that said control signals (d1a, d1b, d2a, d2b, d3a, d3b) are generated by a pulse width modulation (PWM) regulator controlled by a command signal the level of which is substantially equal to the sum of the first and second command signals (V_{A}, V_{B}).

8. Electric energy converter according to claim 5, characterized in that the frequency of the second command signal (V_{B}) is higher than the frequency of the first command signal (V_{A}).

9. Electric energy converter according to claim 1, characterized in that said transformer (40) comprises a primary and at least one secondary, said second output signal (S2) being taken at said secondary, the primary being connected to a first point (M1) situated downstream of said switching means (10).

10. Electric energy converter according to claim 1, characterized in that said transformer (400) is formed by first windings (b10, b20, b30) being respectively connected to each bridge arm (100a, 100b, 100c), the first windings (b10, b20, b30) forming a primary of said transformer (400), and at least one second winding (b40) forming a secondary of said transformer (400), the second output signal (S20) being taken at said secondary.

11. Electric energy converter according to claim 8, characterized in that it comprises a second transformer (30) connected to the bridge arms (10a, 10b, 10c) of the switching means (10), said first output signal (S1) being taken at the secondary (32) of said second transformer (30), and said first point (M1) being the neutral of the primary (31) of said second transformer (30).

12. Electric energy converter according to claim 11, characterized in that the neutral of the primary (31) of said second transformer (30) is connected to the midpoint of the input voltage of the switching means (10).

13. Electric energy converter according to claim 11, characterized in that the primary (31) of said second transformer (30) comprises three windings, one terminal of each winding being connected to the reference potential through capacitors (c1, c2, c3).

14. Electric energy converter according to claim 8, characterized in that a motor is connected to the bridge arms (100a, 100b, 100c) of said switching means (1000), said first point (M1) being the neutral of said motor.

15. Electric energy converter according to claim 11, characterized in that the primary (41) of the transformer (40) is connected to the midpoint (M2) of the input voltage of the switching means (10).

16. Electric energy converter according to claim 8, characterized in that a capacitor (Ca) is connected to each bridge arm (10″a, 10″b, 10″c) by a first terminal, said capacitors (c1″, c2″, c3″) being connected to each other by a second terminal, said first point (M1) being formed by the second terminals of said capacitors.

17. Electric energy converter according to claim 16, characterized in that the primary of the transformer (30″) is connected to the capacitors (c1″, c2″, c3″) and to the reference potential.

18. Electric energy converter according to claim 2, characterized in that each bridge arm (10a, 10b, 10c; 100a, 100b, 100c; 1000a, 1000b, 1000c) of the switching means (10; 100; 1000) comprises at least two switches, said at least two switches of each bridge arm being controlled substantially in opposition by two control signals (d1a, d1b, d2a, d2b, d3a, d3b) respectively, the control signals (d1a, d1b, d2a, d2b, d3a, d3b) being generated from a first and a second command signal (V_{A}, V_{B}), the first command signal (V_{A}) and the second command signal (V_{B}) being applied to each bridge arm (10a, 10b, 10c; 100a, 100b, 100c; 1000a, 1000b, 1000c), the first command signal (V_{A}) being applied with a phase shift such that the voltage of the midpoint is substantially zero.

19. Electric energy converter according to claim 3, characterized in that each bridge arm (10a, 10b, 10c; 100a, 100b, 100c; 1000a, 1000b, 1000c) of the switching means (10; 100; 1000) comprises at least two switches, said at least two switches of each bridge arm being controlled substantially in opposition by two control signals (d1a, d1b, d2a, d2b, d3a, d3b) respectively, the control signals (d1a, d1b, d2a, d2b, d3a, d3b) being generated from a first and a second command signal (V_{A}, V_{B}), the first command signal (V_{A}) and the second command signal (V_{B}) being applied to each bridge arm (10a, 10b, 10c; 100a, 100b, 100c; 1000a, 1000b, 1000c), the first command signal (V_{A}) being applied with a phase shift such that the voltage of the midpoint is substantially zero.

20. Electric energy converter according to claim 12, characterized in that the primary (31) of said second transformer (30) comprises three windings, one terminal of each winding being connected to the reference potential through capacitors (c1, c2, c3).
